(19) United States
(12) Patent Application Publication
(10) Pub. No.: US 2009/0051686 A1
(43) Pub. Date: Feb. 26, 2009

(54) SIMULATION OF DYNAMIC CITY ENVIRONMENTS AND A RELATED FABRICATION METHOD

(75) Inventors: Bernard Paul Remy Legaut, Lyon (FR); Lionel Bruno Barret de Nazaris, Renaison (FR); Frederic Armetta, Villeurbanne (FR); Saida Brondel, Lyon (FR); Salima Hassas, Villeurbanne (FR)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(73) Assignees: Lionel Bruno Barret de Nazaris, Renaison (FR); Bernard Paul Remy Legaut, Lyon (FR); CENTRE NATIONAL DE LA RECHERCHE SCIENTIFIQUE, Paris (FR); UNIVERSITE CLAUDE BERNARD - LYON 1, Villeurbanne (FR)

(21) Appl. No.: 12/195,057

(22) Filed: Aug. 20, 2008

(30) Foreign Application Priority Data
Aug. 20, 2007 (EP) 07291026.8

(51) Int. Cl. G06T 17/50

(52) U.S. Cl. 345/419

(57) ABSTRACT

A method of dynamic generation by computer simulation of spatial elements, in particular, buildings and roads, constituting a three-dimensional city environment, the method comprising providing a supervisor subroutine responsible for overall control of the simulation; providing a spatial reorganization subroutine subordinate to the supervisor subroutine and responsible for generating the city environment on a local scale; placing a spatial element in the simulation; generating an inquiry from the supervisory subroutine which is sent to the spatial reorganization subroutine and providing spatial materialization of the inquiry by the spatial reorganization subroutine, which involves agents wherein at least some of the agents are able to negotiate with one another.

### PRIORITY CLAIM

This patent application claims priority to European Patent Application No. 07291026.8, filed Aug. 20, 2007, the disclosure of which is incorporated herein by reference in its entirety.

### FIELD

The present disclosure relates to generating synthetic graphical environments in three dimensions usable, in particular, for backgrounds in video games or films.

The present disclosure relates, in particular, to methods of generating dynamic city environments in three dimensions by computer simulation.

The present disclosure also relates to a method of dynamic generation by computer simulation of spatial elements, in particular, buildings and roads, constituting a three-dimensional city environment. The method includes a supervisor subroutine responsible for overall control of the simulation and a spatial reorganization subroutine subordinate to the supervisor subroutine which is responsible for generating the city environment on a local scale. The method comprises placing a spatial element in the simulation; generating an inquiry from the supervisory subroutine which is sent to the spatial reorganization subroutine and depends on the spatial element; and providing spatial materialization of the inquiry by the spatial reorganization subroutine, which involves agents.

The present disclosure also relates to a computer program including computer program code means adapted, when the program is executed on a computer, to execute the steps of a method of dynamic generation by computer simulation of spatial elements, in particular, buildings and roads, constituting a city environment in three dimensions.

The present disclosure further relates to a computer program implemented on a computer-readable medium.

The present disclosure relates finally to a computer-readable medium storing a computer program such as the program disclosed hereinabove.

### BACKGROUND

Generating city environments by computer simulation is well known in the art. There are many requirements for this type of technology stemming from the growth of video games and computer-generated images in cinematography.

In particular, demand is turning towards very realistic city environments, for example, simulating towns as known in our time.

To respond to these requirements, it is known, in particular, to use a semi-automatic computer simulation method including a preliminary step of creating specifications.

These specifications include input data concerning the activities to be shown in the simulation of the town and data about the environment of the simulation (relief, bodies of water, woods, etc.). Prior art simulations generally use only four activities, namely residential activity, commercial activity, industrial activity, and parks activity. There are already known computer simulations of city environments that also involve agents that, in response to the specifications, create structures, properties (of residential, industrial, commercial, or park type), and roads. Prior art simulations using agents are multi-agent systems comprising agents disposed in a particular environment. An agent is a virtual entity, i.e., a computer program that operates at least partly autonomously, i.e., without continuous intervention by the user.

Simulation of the city environment generally begins with the agents creating roads. Structures, often buildings, are then placed at random, although taking account of the original specifications.

It is the input data and the interrelationships thereof that steer the development of the simulation and the growth of the city environment. For example, it is well known in this type of simulation for houses to be disposed for the most part in areas of higher ground (high relief), parks near residential areas, and industrial facilities in areas of lower ground (low relief) far from residential areas.

Although such methods automatically produce a computer simulation of a city environment, the methods, nevertheless, have certain drawbacks.

The prior art methods of generating city environments generally do not automatically produce a result that is entirely suitable for the user. To be more precise, the raw results obtained are likely to be satisfactory only at the scale of the town as a whole (i.e., the town plan) and unsuitable for a three-dimensional visit, for example.

The result of those prior art simulations often includes a large number of errors or inconsistencies and would, therefore, be difficult to extrapolate to a three-dimensional plan that could be produced in the real world. In this regard, the simulations obtained include, in particular, errors in terms of inconsistencies between the town and the buildings. For example, the simulation might tend to generate a large cinema in a small space of inappropriate size or, equally unsuitably, a small house in a large space. The user must, therefore, constantly intervene to correct the simulation and the user wastes much time in manual interventions.

In other words, although claimed as “automatic” or “semi-automatic” methods, prior art methods generally require recurrent a posteriori intervention by the user in order to obtain a truly satisfactory result, even on a small scale, and this can be tiresome.

Moreover, the known methods as described have the particular disadvantage of generating simulations of city environments with little detail. This is linked to the very small number of activities used, i.e., only four activities, which obviously significantly limits the level of detail and the variety of the buildings generated in the simulation.

Additionally, the prior art methods do not incorporate the concept of how the city environment is used. For example, densely populated areas are not necessarily served by major roads.

### SUMMARY

The present disclosure describes several exemplary embodiments of the present invention.

One aspect of the present disclosure provides a method of dynamic generation by computer simulation of spatial elements constituting a three-dimensional city environment, the method, comprising (a) providing a supervisor subroutine responsible for overall control of the simulation; (b) providing a spatial reorganization subroutine subordinate to the supervisor subroutine and responsible for generating the city environment on a local scale; (c) placing a spatial element in the simulation; (d) generating an inquiry from the supervisory subroutine which is sent to the spatial reorganization subroutine and depending on the spatial element of step (c); and (e) providing spatial materialization of the inquiry by the spatial reorganization subroutine, which involves agents; wherein at least some of the agents involved in the spatial reorganization subroutine are able to negotiate with one another. Another aspect of the present disclosure provides a computer program, comprising computer program code means adapted to execute the steps of a method when said program is executed on a computer.

A further aspect of the present disclosure provides a computer-readable medium, comprising storage of a computer program and computer program code means wherein said program is executed on a computer-readable medium.

The aspects of the present disclosure remedy the above-mentioned drawbacks and provide a method of generating a dynamic city environment in three dimensions by computer simulation that is more functional and limits intervention by the user.

Another feature of the present disclosure provides a method enabling fast and coherent generation of a dynamic city environment in three dimensions.

Another feature of the present disclosure provides a method of generating a dynamic city environment in three dimensions enabling detailed and realistic computer simulation.

Another feature of the present disclosure provides a method of generating a dynamic city environment in three dimensions enabling logical and organized subdivision of the city environment.

Another feature of the present disclosure provides a method of generating a dynamic city environment in three dimensions enabling dynamic and evolving computer simulation.

Another feature of the present disclosure provides a method of generating a dynamic city environment in three dimensions producing fast and accurate generation of the city environment.

Another feature of the present disclosure provides a method of generating a dynamic city environment in three dimensions enabling transfer of any local inconsistencies to the global level for correction.

Another feature of the present disclosure provides a method of generating a dynamic city environment in three dimensions enabling computer simulation with localized spatial reorganization.

Another feature of the present disclosure provides a method of generating a dynamic city environment in three dimensions by computer simulation in which the changing of the city environment is managed both globally and locally.

Another feature of the present disclosure provides a method of generating by computer simulation a dynamic city environment in three dimensions enabling the city environment to progress with relatively little limitation by geographical relief.

### BRIEF DESCRIPTION OF THE DRAWINGS

Various aspects of the present disclosure are described hereinbelow with reference to the accompanying figures, which are provided by way of non-limiting illustration only, and in which:

FIG. 1 is a functional block diagram of the main steps of the method of the present disclosure of dynamically generating by computer simulation a city environment in three dimensions;

FIG. 2 is a diagram showing one implementation of step (b) of the method of the present disclosure, in which a proposal is generated by a building following an inquiry by the supervisor subroutine of the present disclosure with the aim of adding a building;

FIG. 3 is a diagram showing one implementation of step (c) of the method of the present disclosure, in which a courtyard generates a spatial reorganization proposal following inquiry by the supervisor subroutine of the present disclosure with the aim of adding a building; and

FIG. 4 is a diagram showing one implementation of step (c) of the method of the present disclosure, in which an inquiry by the supervisor subroutine of the present disclosure with the aim of adding a building leads to negotiation between buildings.

### DETAILED DESCRIPTION

The invention of the present disclosure concerns a method of generating a dynamic city environment in three dimensions by computer simulation. For purposes of the present disclosure, a city environment is a town or a village or any other area shaped by man (or any other real or imaginary creature having sufficient capabilities for this purpose) and comprising structures. A city environment is preferably a space containing dwellings, for example, human dwellings, and buildings representing activities, for example, human activities such as industrial and commercial activities, in particular.

For purposes of the present disclosure, the term “computer simulation” refers to a set of techniques for imitating a real city environment as realistically as possible using programs incorporating mathematical models based on parameters encountered in the real world.

The method of the present disclosure enables dynamic generation of the city environment, meaning that the generation is not static or fixed a priori, but, on the contrary, is determined as the execution of the computer simulation proceeds and in accordance with what the user requires. For purposes of the present disclosure, the term “generation” refers to the action of automatically generating data from other data, in particular, from input data as defined hereinbelow. The dynamic generation of the city environment is preferably automatic, i.e., is partly autonomous and does not require continuous human intervention.

The city environment as defined above integrates spatial elements, in particular, buildings, roads, and other urban structures. For purposes of the present disclosure, the term “building” refers to any urban object permanently occupying a plot of land. For purposes of the present disclosure, a statue, a tree, or a park constitutes a “building” on the same terms as structures comprising at least a wall and a roof, such as houses, apartment blocks, factories, commercial properties, churches, and the like. For purposes of the present disclosure, roads are preferably roads as encountered in the real world, that is to say roads of various sizes. The roads of the present disclosure can, in particular, be roads with one or more lanes, one-way or two-way, highways, orbital highways, bypasses, national highways, regional highways, tracks, express and/or fast lanes. For purposes of the present disclosure, the term “road” also encompasses imaginary roads, with no equivalent in the real world.

The city environment of the present disclosure is in three dimensions, i.e., the city environment takes into account the volumes and sizes of the various spatial elements constituting the city environment.

The method of the present disclosure includes a supervisor subroutine responsible for overall control of the simulation. This subroutine advantageously monitors how the simulation progresses. In particular, the supervisor subroutine has an overview with relatively little detail of the city environment as created, and the main objective of the supervisor subroutine is to produce a city environment that is coherent. It is preferable for the supervisor subroutine to monitor progress in the generation of the city environment as a whole but without viewing in detail what is happening locally.

In this regard, the method of the present disclosure consequently further includes a spatial reorganization subroutine subordinate to the supervisor subroutine and responsible for generating the city environment on a local scale. This subroutine provides for spatial reorganization, that is to say for obtaining on a local scale the best possible spatial arrangement of the spatial elements to satisfy the main objective, i.e., the coherence of the city environment. For purposes of the present disclosure, a coherent city environment is preferably one that comprises few or no simulation errors, for example, positioning or usage errors, and is very close to city environments in the real world.

The method of the present disclosure comprises steps that use the above two subroutines and any interactions that might exist between them. During a substep (a₀), specifications are preferably provided to serve as simulation input data, the specifications preferably comprising one or more activities, preferably a plurality of activities, and a relief map of a world.

The substep (a₀) of creating a plurality of specifications serving as simulation input data is executed before the computer simulation is started. For purposes of the present disclosure, these specifications consist of information that the user provides before starting the simulation.

The specifications used in the substep (a₀) preferably consist of data concerning the relief on which the city environment will be generated and concerning the activities, for example, human activities, that the user wishes to see in the simulation. For purposes of the present disclosure, the term “relief” preferably refers to the environment in general, i.e., everything that is not the town (unbroken ground, forests, bodies of water, etc.).

For purposes of the present disclosure, the term “activities” concerns all functions of buildings and structures.

The functions of building and structures are preferably commercial activities (grocers, bakers, department stores, restaurants, hotels, and the like), industrial activities (industrial estates, steelworks, textile factories, and the like), educational activities (primary schools, secondary schools, grammar schools, universities, and the like), housing activities (homes, detached houses, individual houses, housing developments, apartment blocks, and the like), administrative activities (town halls, police stations, ministries, and the like), sporting activities (leisure centers, municipal swimming pools, gymnasiums, sports fields, tennis courts, and the like), leisure activities (parks, zoos, cinemas, and the like), and/or religious activities (churches, cathedrals, and the like). The list hereinabove is in no way limiting on the present disclosure, and any other activity can be envisaged, even an imaginary activity.

The activities of the substep (a₀) advantageously interact with one another. Each activity can preferably interact with one or more other activities. Depending on the activity associated with a spatial element, the position of the spatial element in the simulation preferably tends to be attractive or repulsive relative to other activities.

Placing a cinema, representing a leisure activity, in the city environment of the present disclosure will tend to attract commercial activity, for example, restaurants and bars. Likewise, generating a university will tend to attract nearby student housing in the evolving city environment, for example.

Thus activities can preferably interact with one another and attract or repel each other. Educational activity will tend to attract housing activity, for example, whereas industrial activity will tend to repel housing activity. The main function of these activities is to increase the capabilities of the simulation and to increase very significantly the level of detail of the city environment.

Once the user has entered the specifications into the program, the simulation can begin. The method comprises a step (a) of placing in the simulation, for example, at random, a spatial element meeting the specifications created in the substep (a₀). The spatial element is preferably a building associated with an activity as defined hereinabove.

The spatial element created during step (a) is preferably a three-dimensional agent. In the context of the present disclosure, an agent is a virtual entity, i.e., a computer program, that functions at least partly autonomously, i.e., without continuous intervention by the user. Moreover, according to the present disclosure, an agent preferably has a personal objective, i.e., a constraint linked to the function with which the agent is associated, the constraint preventing the agent from undergoing incoherent spatial reorganization. In other words, an agent has objectives that are specific to the agent and that depend at least in part on the activity with which the agent is linked.

Agents can preferably “perceive” their near environment, i.e., agents can react to nearby elements.

The agents in the simulation of the present disclosure preferably perceive a space that is restricted and are capable of interacting at least in the restricted space in which the agents are placed, or at most in the whole of the city environment. An agent advantageously has a personal objective and its perception is advantageously limited to a specific space.

The city environment is advantageously divided into blocks, and a first spatial element is placed in a first block. In the context of the present disclosure, a block corresponds to a limited area in space, i.e., a restricted space surrounded by roads and on which buildings are placed. Obviously, the size and the shape of the blocks of the generated city environment are advantageously variable. The subdivision of the city environment into blocks advantageously grids the computer simulation space and creates a basic spatial unit of the city environment. Of course, the city environment is not divided into blocks a priori, the blocks forming as creation of the town proceeds. Thus roads are constructed, and after a certain amount of time the roads intersect to form blocks which can therefore be open or closed.

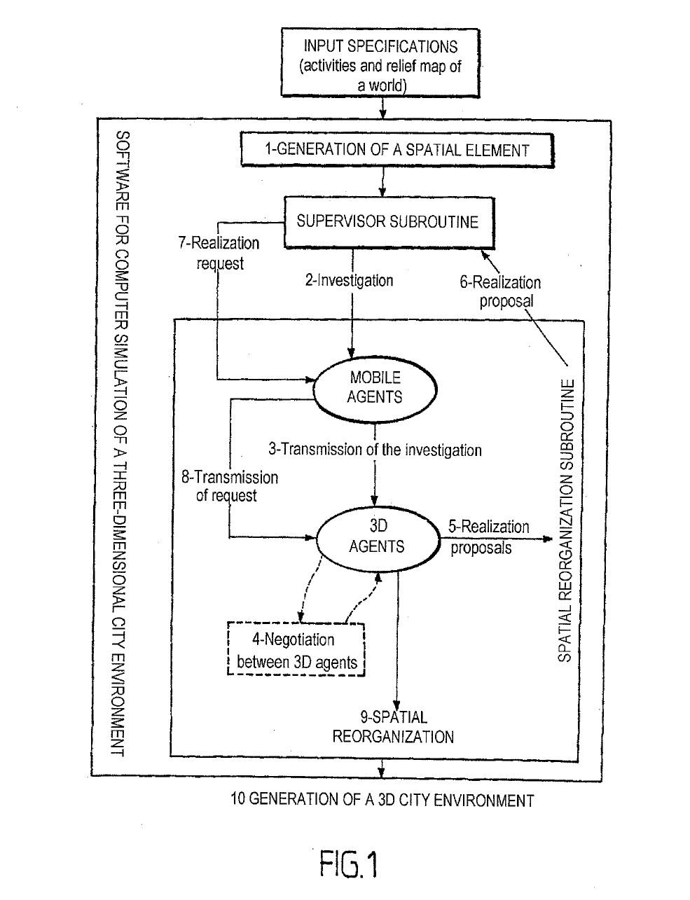

The method of the present disclosure then includes a step (b) in which the supervisor subroutine generates an inquiry that depends on the spatial element of step (a) and that is sent to the spatial reorganization program. During this step, and in view of the spatial element that has been placed, as shown diagrammatically in FIG. 1, the supervisor subroutine sends an inquiry to the spatial reorganization subroutine, the inquiry concerning progress of the generated city environment. The spatial element generated preferably belongs to an activity defined in the specifications. The city environment, therefore, progresses as a function of that activity and the type of spatial element created (house, school, and the like).

The supervisor subroutine used in step (b) preferably exercises central control of the simulation and sends inquiries in respect to progress in the city environment.

The inquiry, which preferably takes the form of an investigation applicable to one or more blocks, can relate to adding a road or a building, for example. The inquiry preferably produces different kinds of information:

A type of object to be placed, from which certain characteristics and optional local additional objectives can be deduced. For example, a commercial facility must be placed at the roadside and extend at least five meters, or a road must subdivide a block between two precise positions.

A weighting that represents the benefit of the placement. In this regard, a weight associated with the placing of the object is related to a cost of the spatial reorganization that placing the object causes, the spatial reorganization cost including, in particular, development costs in respect of the buildings or roads affected.

The inquiry is addressed to the reorganization subroutine. Once the supervisor subroutine has sent the inquiry, the method executes a step (c) of spatial materialization of the inquiry by the spatial reorganization subroutine which causes the agents to intervene.

The agents intervening in step (c) are preferably mobile agents and static agents. They are preferably virtual entities as defined above, i.e., autonomous units for generating a coherent city environment.

The mobile agents advantageously move in the city environment and have as their main objective the construction of a coherent transport network. This main objective leads to logical and realistic progress of the computer simulation, preferably by constructing roads between buildings.

The mobile agents can preferably interact directly with the supervisor subroutine, preferably by sending proposals to the supervisor subroutine. The mobile agents are advantageously the navigators of the system and the mobile agents send the supervisor subroutine information about the city environment. For example, the mobile agents inform the supervisor subroutine that a road is no longer being used or that a building should be eliminated. The mobile agents preferably propose to the supervisor subroutine items that the changing city environment needs or wants. The supervisor subroutine advantageously analyses these proposals and can send inquiries as defined hereinabove relating to the proposals.

The final decision is preferably taken by the supervisor subroutine which requests a mobile agent to carry out an investigation.

The mobile agents are preferably spatial reorganization messengers for locally formulating the inquiry the supervisor subroutine sends in step (b).

A mobile agent preferably receives an investigation from the supervisor subroutine, for example, a request to construct a cinema in a particular block. The mobile agent advantageously sends the investigation at the local level of the city environment, i.e., to the spatial reorganization process, and preferably at block level. The mobile agent is preferably part of the spatial reorganization subroutine and can initiate spatial reorganization, but is not itself subject to spatial reorganization.

The mobile agents are preferably an interface between the supervisor subroutine and the spatial reorganization subroutine.

The purpose of the spatial reorganization step (d) is advantageously to render the inquiry in concrete terms at the spatial level in the city environment.

The spatial reorganization subroutine preferably sends a proposal to the supervisor subroutine, in particular, to provide for the best spatial arrangement in response to the inquiry, especially by placing optimally any spatial element contained in the inquiry.

The spatial reorganization subroutine preferably uses static agents to send this proposal to the supervisor subroutine, as shown in FIG. 1. The static agents are advantageously three-dimensional agents able to negotiate with one another. The three-dimensional agents are preferably defined in exactly the same way as the spatial element of step (a), i.e., the three-dimensional agents are preferably buildings and/or roads disposed around and in the blocks of the city environment.

The three-dimensional agents of the present disclosure preferably have personal objectives depending on their natures, i.e., depending on the activities with which the three-dimensional agents are associated. For example, a cinema agent has specific objectives that prevent the cinema from being placed in a block that is too small in relation to the minimum size of a cinema. For purposes of the present disclosure, an agent has objectives that are specific to that agent.

Alternatively, and without departing from the scope of the present disclosure, the three-dimensional agent is a structure, for example, a building, a bridge, a church, a house, a cinema, a leisure center, a road, or any other urban object as defined hereinabove (statue, tree, park, and the like).

The three-dimensional agents of the present disclosure are preferably able to negotiate with one another, i.e., can interact and communicate with one another. Negotiation between three-dimensional agents preferably operates only the block scale, i.e., the three-dimensional agents of the same block as defined above interact with one another according to an inquiry sent by the supervisor subroutine and transmitted by the at least one mobile agent. In other words, three-dimensional agents of the same block can examine an inquiry sent by the supervisor subroutine and transmitted by the mobile agents in order to communicate and to deliberate conjointly with a view to arriving, if possible, at a coherent spatial reorganization proposal in response to the inquiry.

The method of the present disclosure is advantageously intended to generate roads and buildings that are three-dimensional agents able to negotiate with one another. Moreover, the spatial element placed in the city environment during step (a) is one of the agents, in particular, the three-dimensional agents, operative in the spatial reorganization subroutine and able to negotiate with one another. This spatial element is, therefore, a road or a building on the same terms as the other three-dimensional agents.

In this city environment, each road and each building is a separate computer program able to interact with the other roads and buildings of the block in which the road or building is placed.

For purposes of the present disclosure, negotiation is an exchange of information, a discussion or any other interaction between three-dimensional agents with the aim of the three-dimensional agents agreeing on a spatial reorganization that is most appropriate to the received investigation. The negotiation between three-dimensional agents preferably relates to their shapes, dimensions, and placements, in particular, as a function of the activities with which they are associated and their own objectives.

Negotiation between the three-dimensional agents of a block advantageously leads to a coherent proposal for all the agents of the block and for progress of the city environment as a whole. Each three-dimensional agent preferably has a personal objective and its perception is preferably limited to its near environment, preferably to the block in which the three-dimensional agent is located. In other words, according to the specific objectives of each agent and according to the inquiry sent, negotiation can lead to greater or lesser spatial reorganization.

This negotiation is of particular benefit in that it avoids the errors found in prior art simulations. Spatial reorganization in accordance with the present disclosure takes continuous account of local objectives and of the overall progress of the city environment. The negotiation capability conferred on the agents ensures, in particular, consistency between, firstly, the size and shape of the plot and, secondly, the type of building to be installed on the plot in question. For example, the buildings (that are agents in this instance) can preferably negotiate with one another to obtain a plot corresponding to what the buildings require (for example, large plot for a cinema).

The fact that each building is a three-dimensional agent is highly advantageous and enables generation on the local scale of an environment that is particularly reliable and detailed. This technical feature makes the city environment realistic with an appearance visualization close to that of existing towns. This technical feature also significantly improves on prior art methods in which buildings are not agents. Furthermore, since the roads and buildings of the present disclosure are agents able to negotiate with one another, it is possible to generate the roads and buildings simultaneously, which is not true of prior art methods in which creating a network of roads always precedes creating buildings.

With the present disclosure, roads and buildings forming three-dimensional agents in the city environment can be generated at the same time. The present disclosure therefore creates the network of roads in parallel with or even simultaneously with that of the buildings, as a function of the type of inquiry sent. The dynamic generation method of the present disclosure enables synchronized creation of buildings and roads. This synchronization is made possible firstly by the intervention of the supervisor and spatial reorganization subroutines, and secondly by the negotiation between three-dimensional agents, in particular, between roads and buildings.

This technical feature improves the consistency and the speed with which the city environment is generated, compared to prior art generation methods which generally first create a subdivision of the city environment by means of roads, with buildings being placed in a second stage once the road network has been completed.

The negotiation preferably also includes a value criterion. Each three-dimensional agent has a starting value that depends mainly on its function. This value of the three-dimensional agent can vary, preferably as a function of the duration of involvement of the three-dimensional agent in the simulation and the negotiations in which the three-dimensional agent participates. Agents, therefore, advantageously do not have the same value, and negotiations are, therefore, influenced by these values.

For example, if the supervisor subroutine requests the creation of a commercial facility in a block where there are a church and houses, the three-dimensional agents that constitute the houses, the church, and the commercial facility begin to negotiate to determine what the best spatial reorganization might be. In the simulation, old houses in the city environment have a higher value than houses recently created. Similarly, the church has a function that confers on it a value much higher than the houses present and the commercial facility to be installed. It is highly unlikely, in this example, that the church would be eliminated in favor of the commercial facility.

Each building is able to send a spatial reorganization proposal as a function of the investigation received and of its personal objectives in a given context.

Two situations are distinguished:

When a building b@B initiates the reorganization, the building merely considers the context of the current environment c@C at the position indicated by the supervisor process in order to send the following spatial reorganization proposal:

Fₚᵣₒₚₒₛₐₗ(b\b@B, c\c@C)@P^{b}

When a building is the subject of the reorganization, the building must consider that some parts p@P of its environment cannot be called into question in order to send the following proposal:

Fₚᵣₒₚₒₛₐₗ(b\b@B, c\c@,C, p\p@P)@P^{b}

Fₚᵣₒₚₒₛₐₗ is a non-deterministic function, i.e., different executions of the function can yield different proposals. In other words, the proposal function can preferably produce different proposals in exactly the same context for exactly the same inquiry. A three-dimensional agent can preferably use this function more than once in order to draw up a list of proposals.

Furthermore, it is possible to determine the satisfaction score of a building for a proposal by using the following function:

Weighting (pp@Pb) @@

Negotiation between three-dimensional agents preferably leads the spatial reorganization subroutine to send a realization proposal to the supervisor subroutine, the proposal taking into account local negotiations between the three-dimensional agents in relation to the inquiry sent by the supervisor subroutine relating to the changes in the city environment. This local negotiation between agents, in particular, between buildings, has the particular function of enabling local spatial reorganization most appropriate to the overall object for progress of the city environment.

In the context of the present disclosure, the three-dimensional agents are buildings. In other words, negotiation between buildings forming three-dimensional agents leads the spatial reorganization subroutine to send a realization proposal to the supervisor subroutine, the proposal reporting local negotiations between the buildings in relation to the at least one inquiry sent by the supervisor subroutine relating to the progress of the city environment.

Thus negotiation between buildings, which are separate agents, clearly improves the coherence of the city environment and enables particularly efficient, fast, and harmonious dynamic generation thereof, at the same time as limiting human intervention.

The proposal sent by the spatial reorganization subroutine to the supervisor subroutine can preferably vary according to the negotiations between the three-dimensional agents concerned.

The spatial reorganization subroutine can preferably accept the investigation and propose a realization, indicate collateral effects linked to an investigation or refuse to carry out the investigation.

It is advantageous if not all investigations sent by the supervisor subroutine always lead to a spatial materialization in the city environment. If negotiation between agents concerned by the investigation proposes not to add a new commercial facility to a block, for example, the spatial reorganization subroutine sends that response to the supervisor subroutine, which takes the final decision. Faced with a negative response from the spatial reorganization subroutine, it is unlikely that the supervisor subroutine would impose the reorganization.

Steps (a), (b), and (c) are advantageously repeated as many times as necessary during the computer simulation to generate a city environment. Repeating these steps of the method preferably enables dynamic growth of the agents of the city environment and consequently growth of the city environment itself.

Each time the user relaunches the computer simulation with the same input specifications, the city environment generated is preferably different. The computer simulation in the sense of the present disclosure is, therefore, preferably of a random kind.

### EXAMPLES

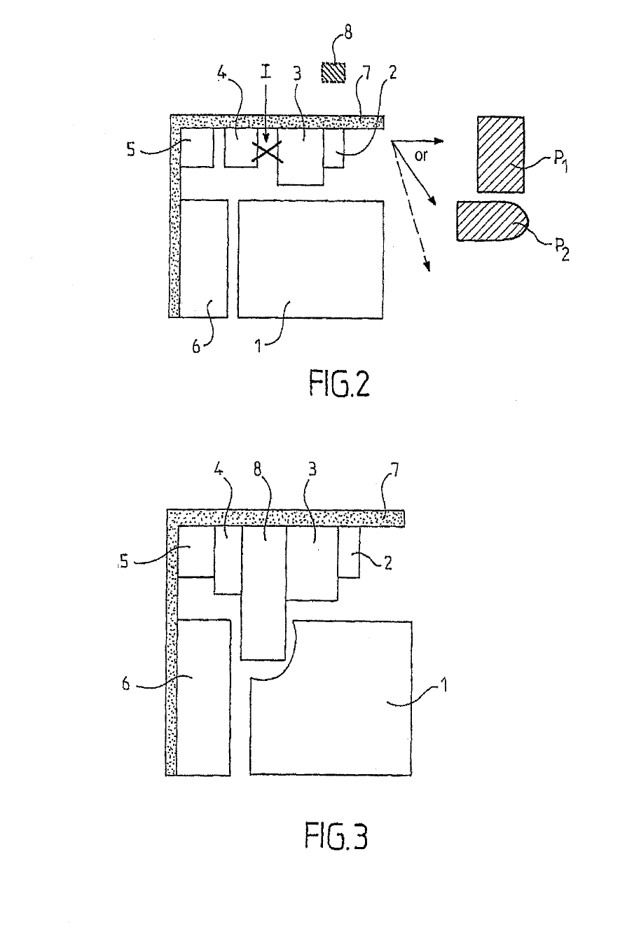

The supervisor subroutine sends an investigation I for the block shown in FIG. 2. The supervisor subroutine seeks the construction of a new building 8 between two existing buildings 3, 4 on the block.

Before spatial reorganization proposals can be sent, the three-dimensional agents, i.e., the buildings 2, 3, 4, 5, the road 7, the courtyard 1, and the building 8 to be installed on the block, must negotiate with one another. The new building 8 to be installed proposes that the new building be inserted in the city environment in the form P₁ or P₂, as shown in FIG. 2.

The proposal functions can preferably be more or less complex, i.e., the proposal functions can be simple initially (static patterns to be proposed) and more sophisticated thereafter (additional parameters for realistic rendering of the city environment, and the like). The spatial reorganization subroutine is advantageously not modified if the proposal functions change.

According to the proposal P₁ or P₂ for the building 8 and the function and the value of the courtyard 1, the courtyard 1 sends the spatial reorganization proposal shown in FIG. 3.

The non-road areas between the buildings, for example, between the buildings 5 and 6, serve as buffer zones and they are not directly involved in the spatial reorganization subroutine.

A geographical engine advantageously calculates the areas of overlap during propagation of a spatial reorganization. The geographical engine can also be used within the proposal functions, for example, within the deformation function or the offsetting function.

As a general rule, the spatial reorganization subroutine preferably comprises steps of evaluating and validating spatial reorganization of a building.

In a first step, a spatial reorganization network is generated that preferably relates different proposals expressed locally. Furthermore, the spatial reorganization network can advantageously perceive the best available spatial organization among those expressed by the three-dimensional agents concerned.

The production of the spatial reorganization network is defined, in pseudo-code, by the following synthetic function:

NetworkGeneration Network Function (b@b@B)

File file=File(b)

Network network

While (!is Empty(file))

{

List listProp = getProposal(get(file)) //

recovery of proposals from the agent

For all Pᵢ in listProp

{

addProposalNode(network, Pᵢ) //
construction of the network
List listAgentimpact = getimpact(Pᵢ)
// recovery of agents
// the proposal concerns (using

the geographical engine)

addFile(file, listAgentimpact) //
each agent must propose an //
adaptation to the disturbance

}

return network

}

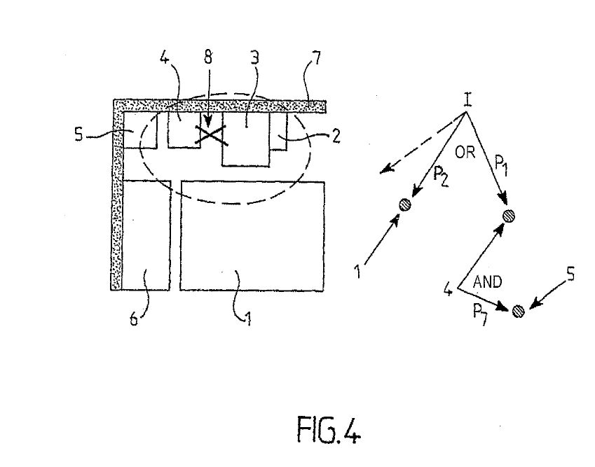

A graph is preferably formed as soon as a building (or a road) is involved in distinct branches during generation of the spatial reorganization network. It is then advantageous to guarantee that the proposals expressed are not mutually contradictory, especially if the proposals belong to the same solution pattern, i.e., if the proposals have a common parent of AND node type, as shown in FIG. 4. The function Fₚᵣₒₚₒₛₐₗ preferably then considers a number of constraints to send this proposal.

A second step preferably evaluates and validates the spatial reorganization of a building. This step preferably perceives the most beneficial spatial reorganization.

The network, as described above, expresses a number of alternatives (OR node) or composite alternatives (AND node). The best weighting and the sum of the weightings preferably propagate in the reorganization network in order to express reliably the cost of spatial reorganization.

During spatial reorganization, a subtree (subnetwork) that is the most advantageous for the spatial reorganization is preferably stored. In FIG. 4, when the agent 8 propagates the perception to the agent 4, the agent 4 must itself perceive it before sending its own response (to the agent 5). The agent 4 sends a satisfaction score that depends on its own satisfaction and that of the agent 5, the composition functions remaining to be defined. For purposes of the present disclosure, the term “satisfaction score” corresponds to perception by the agent of a state enabling the agent to approximate as closely as possible its own objectives while taking the best possible account of the overall objectives of the city environment.

A road can advantageously be seen as an agent that sends proposals (calculated in accordance with its own objectives) and perceives local objects of the environment that those proposals disturb, preferably the block or blocks that the road delimits. A block could express its spatial reorganization capacity, in particular, at the level of its area surface and its maximum area, by the same method as that used for the buildings affected. A number of network architectures can, therefore, preferably be envisaged.

Alternatively, without departing from the scope of the present disclosure, it is possible to envisage negotiation between houses within a half-plan or within a group of houses. In the method described, no distinction is drawn between a half-plan and a group of houses, the spatial reorganization being preferably set up in the same way in both situations.

During changes of the city environment, roads and houses are caused to negotiate with one another. For example, if a road is to be installed, the road sends route proposals. The cost of each route proposal is calculated from the spatial reorganization proposals sent by the houses conforming to it. The spatial reorganization network advantageously perceives the lowest spatial reorganization cost. The spatial reorganization cost preferably relates to the benefit of placing the road in order to deduce whether or not to realize the route proposal.

Spatial reorganization preferably modifies at least part of the relief of the world in relief on which the city environment is generated, as defined hereinabove. There is advantageously a two-fold relationship between the agents and the relief: the relief can affect the placement of a three-dimensional agent (for example, a port is preferably installed near the sea, a sawmill tends to be positioned near a forest, and the like); the three-dimensional agent can affect the relief (a sawmill uses wood and tends to cause the forest to move back, a house can require leveling of the land before it is installed, and the like).

This two-fold relationship between the agents and the relief preferably has the main function of contributing to the generation of a coherent city environment.

There can advantageously be negotiation between a road and a relief. For example, if the relief is too steep, the road is routed another way or the road modifies the relief to some degree. If the road sends a proposal, it is the road that individually attests to its feasibility in the routes that the road proposes.

As the city environment changes, it is preferably possible for blocks to be subdivided. If the density of the buildings of a town increases, i.e., in particular, if the growth of the agents increases, a town-center block can be divided in two. If the density of the structures continues to increase and, below a certain size, the block can no longer be subdivided, the buildings become high-rise buildings with growth preferably being vertical by stacking.

The blocks are advantageously subdivided when the supervisor subroutine requests it, for example, on proposing to place a road.

It is preferably also feasible to subdivide the blocks if the blocks know their own objectives (size, economic consistency, and the like), which objectives can vary during the simulation. A block generating a proposal to split itself into two parts can be envisaged if such subdivision would enable the block to increase its satisfaction score. Once again, the block compares its individual objectives with the overall configuration of the city environment that is being generated.

The method of the present disclosure preferably generates a coherent environment, for example, a realistic environment close to reality, in particular, because of the negotiation between the three-dimensional agents which significantly reduces errors and repetitive human intervention, as is known in the prior art. The three-dimensional agents of the present disclosure, preferably all the structures, are preferably positioned precisely and exactly in the city environment, which was not true in prior art methods.

Moreover, in the method of the present disclosure, the user can decide at any time to stop the computer simulation. The generation of the city environment is then stopped and the user can decide to effect manual manipulations, for example. Moreover, unlike prior art simulations that yield results with little scope for editing, the method of the present disclosure enables modification of sub-parts at the end of the simulation or pausing of the simulation to effect modifications.

The user can preferably edit a simulation result manually or relaunch the simulation manually as soon as desired. The user can advantageously also eliminate or add elements manually while the city environment is being generated. Moreover, after such addition or elimination, the user can, in particular, choose to relaunch the computer simulation of the invention, i.e., dynamic generation of a city environment without intervention by the user.

In the method of the present disclosure, the user can also advantageously add constraints relative to the starting specifications to obtain different variation of the city environment.

The present disclosure advantageously also concerns a computer program comprising computer program code means adapted to execute the steps of a method as described hereinabove when the program is executed in a computer.

A computer program is preferably a series of instructions written in a form that a computer can understand to process a problem or to carry out a task.

The computer program as defined hereinabove is preferably implemented on a computer-readable medium. In the context of the present disclosure, the medium is preferably a data processing element intended to receive the computer program adapted to execute the method of the present disclosure. The medium is advantageously an internal or external hard disk, a mother board, a CD-ROM, a diskette, a DVD, a USB key, a mobile telephone SIM card, a GPS, and the like.

The present disclosure preferably further relates to a computer-readable medium storing a program as defined hereinabove. The medium is advantageously the same as that defined hereinabove.

The method of the present disclosure has many advantages over the prior art. In particular, the method produces a city environment containing few or even no errors in respect of the placement of spatial elements, such as roads and buildings, in particular.

Furthermore, the method of the present disclosure positions spatial elements exactly, accurately, and reproducibly, in particular, because of the permanent interaction between the agents and also between the supervisor subroutine and the spatial reorganization subroutine. The interaction between agents and between subroutines produce the spatial reorganization best suited to the city environment as well as limiting human intervention and human modeling errors.

Moreover, because of the use of a large number of activities and interactions between those activities, the city environment generated by the method of the present disclosure is very detailed and comprises a great variety of spatial elements. This advantage also produces a particularly realistic and detailed city environment, which is not true of the prior art city environments.

Moreover, the method of the present disclosure achieves great consistency between the buildings and the town as a result, in particular, of the negotiation between buildings before spatial reorganization. This technical feature produces a city environment close to reality that can be used as such in many applications.

It is in particular possible to envisage using the result of the computer simulation as defined by the present disclosure for virtual backgrounds of video games. The city environment generated by the method of the present disclosure can also be used for computer-generated backgrounds in films. Alternatively, the city environment of the present disclosure can be used in all applications requiring a city environment that is realistic or imaginary and dynamic (video games, cinematography, town planning, modeling, mapping, and the like).

What is claimed is:

1. A method of dynamic generation by computer simulation of spatial elements constituting a three-dimensional city environment, the method, comprising:
(a) providing a supervisor subroutine responsible for overall control of the simulation;
(b) providing a spatial reorganization subroutine subordinate to the supervisor subroutine and responsible for generating the city environment on a local scale;
(c) placing a spatial element in the simulation;
(d) generating an inquiry from the supervisory subroutine which is sent to the spatial reorganization subroutine and depending on the spatial element of step (c); and
(e) providing spatial materialization of the inquiry by the spatial reorganization subroutine, which involves agents;
wherein at least some of the agents involved in the spatial reorganization subroutine are able to negotiate with one another.

2. The method of claim 1, wherein a plurality of specifications are supplied in substep (c₀) to serve as simulation input data, said specifications including one or more activities and a relief map of a world.

3. The method of claim 2, wherein the activities of substep (c₀) interact with one another.

4. The method of claim 1, wherein the city environment is divided into blocks.

5. The method of claim 1, wherein the spatial element created during step (c) is a three-dimensional agent.

6. The method of claim 5, wherein the spatial element is one of the agents that are involved in the spatial reorganization subroutine and can negotiate with one another.

7. The method of claim 1, wherein the agents involved in step (e) are mobile agents and static agents.

8. The method of claim 7, wherein the mobile agents move in the city environment and the main objective of the mobile agents is to construct a coherent transport network.

9. The method of claim 7, wherein the mobile agents are spatial reorganization messengers and locally formulate said inquiry sent by the supervisor subroutine in step (d).

10. The method of claim 7, wherein the mobile agents can interact directly with the supervisor subroutine.

11. The method of claim 7, wherein the mobile agents constitute an interface between the supervisor subroutine and the spatial reorganization subroutine.

12. The method of claim 7, wherein the static agents are three-dimensional agents able to negotiate with one another.

13. The method of claim 12, wherein each three-dimensional agent has a personal objective and its perception is limited to its near environment.

14. The method of claim 12, wherein negotiation between three-dimensional agents is operative only at block scale.

15. The method of claim 12, wherein negotiation between three-dimensional agents leads the spatial reorganization subroutine to send the supervisor subroutine a realization proposal reporting local negotiations between three-dimensional agents in respect to said inquiry sent by the supervisor subroutine for the purpose of making the city environment progress.

16. The method of 15, wherein the three-dimensional agents are buildings.

17. The method of claim 12, wherein roads and buildings that are three-dimensional agents are generated and can negotiate with one another.

18. The method of claim 12, wherein the roads and buildings forming three-dimensional agents can be generated at the same time in the city environment.

19. The method of claim 2, wherein spatial reorganization modifies at least part of the relief of the world in relief on which the city environment is generated.

20. A computer program, comprising computer program code means adapted to execute the steps of a method when said program is executed on a computer.

21. The computer program of claim 20, wherein said program is executed on a computer-readable medium.

22. A computer-readable medium, comprising storage of a computer program and computer program code means wherein said program is executed on a computer-readable medium.
